(19) United States
(12) Patent Application Publication
(10) Pub. No.: US 2024/0036902 A1
(43) Pub. Date: Feb. 1, 2024

(54) ACCUMULATIONS OF MEASUREMENTS FOR ATTESTATIONS

(71) Applicant: Microsoft Technology Licensing, LLC, Redmond, WA (US)

(72) Inventors: Prashant DEWAN, Portland, OR (US); Abhilasha BHARGAV-SPANTZEL, El Dorado Hills, CA (US)

(73) Assignee: Microsoft Technology Licensing, LLC, Redmond, WA (US)

(21) Appl. No.: 17/873,887

(22) Filed: Jul. 26, 2022

(51) Int. Cl. G06F 9/455; G06F 21/57

(52) U.S. Cl. CPC G06F 9/45558; G06F 21/575; G06F 2009/4557

(57) ABSTRACT

According to examples, an apparatus may include a processor that may send, to a measurements manager (MM), a first measurement for the processor, cause a hardware and/or a software to send a second measurement to the MM, and cause a virtual machine (VM) to send a third measurement to the MM. The processor may also cause the MM to accumulate the first measurement, the second measurement, and the third measurement and cause the MM to output the accumulated measurements from the MM for attestation of the processor, the hardware and/or the software, the VM, or a combination thereof.

### BACKGROUND

In a cloud environment, virtual machines (VMs) often execute on computing devices owned by cloud service providers (CSPs). The use of VMs is ever increasing because they are able to isolate specific applications, tasks, or users. Particularly, VMs may include a guest operating system supported on a host, in which the guest operating system does not have control to the physical hardware of the computer system. A VM management system (sometimes referred to as a VM monitor or a hypervisor) is also often employed to manage one or more VMs so that multiple VMs may run on a single computing device concurrently.

### BRIEF DESCRIPTION OF THE DRAWINGS

Features of the present disclosure are illustrated by way of example and not limited in the following figure(s), in which like numerals indicate like elements, in which:

FIG. 1 depicts a block diagram of an apparatus that accumulates measurements for attestation, and outputs the accumulated measurements for attestation, in accordance with an embodiment of the present disclosure:

FIG. 2 depicts a block diagram of a system within which the apparatus depicted in FIG. 1 is implemented, in accordance with an embodiment of the present disclosure;

FIG. 3 depicts a flow diagram of a process for measurements reporting, in accordance with an embodiment of the present disclosure;

FIG. 4 depicts a flow diagram of a process for measurements reporting including an attestation chain for a secure boot sequence, in which measurements are reported to a measurements manager outside of the attestation chain, in accordance with an embodiment of the present disclosure;

FIG. 5 depicts a block diagram of a system, including a global measurements collection center and a plurality of data centers including a super measurements manager, within which the apparatus depicted in FIG. 1 is implemented, in accordance with an embodiment of the present disclosure;

FIG. 6 depicts a flow diagram of a method for accumulating measurements for attestation at a measurements manager and outputting the accumulated measurements in response to a request for attestation, in accordance with an embodiment of the present disclosure; and

FIG. 7 depicts a block diagram of a computer-readable medium that has stored thereon computer-readable instructions to accumulate measurements for attestation at a measurements manager, and to update the accumulated measurements based on updated measurements from an updated device, in accordance with an embodiment of the present disclosure.

### DETAILED DESCRIPTION

For simplicity and illustrative purposes, the principles of the present disclosure are described by referring mainly to embodiments and examples thereof. In the following description, numerous specific details are set forth in order to provide an understanding of the embodiments and examples. It will be apparent, however, to one of ordinary skill in the art, that the embodiments and examples may be practiced without limitation to these specific details. In some instances, well known methods and/or structures have not been described in detail so as not to unnecessarily obscure the description of the embodiments and examples. Furthermore, the embodiments and examples may be used together in various combinations.

Throughout the present disclosure, the terms “a” and “an” are intended to denote at least one of a particular element. As used herein, the term “includes” means includes but not limited to, the term “including” means including but not limited to. The term “based on” means based at least in part on.

In a cloud environment, virtual machines (VMs) often execute on computing devices owned by cloud service providers (CSPs). In some examples, the VMs execute on virtual machine managers (VMMs) on top of platforms owned by the CSPs. A level of trust that may be ascribed to the VMs may be dependent on the security and trustworthiness of the components of the CSPs and the VMMs on which the VMs may execute. Relying parties (RPs), such as tenants of the VMs, may determine the level of security and trustworthiness of the VMs through attestation of the VMs and the components of the CSPs, for instance, during boot time via a secure boot process.

Attestation as used herein may be defined as a process to prove or verify an identity, a property, a state, or the like of a software or a hardware. Attestation may prove to, for instance, a remote party that an operating system, software, hardware, or the like, are intact and trustworthy. In some examples, attestation may include a process of transmitting a sequence of hashes of certain system components and a digital signature of that sequence.

A concern associated with attestation of VMs may be that the VMs may be untrustworthy, or become untrustworthy, for various reasons, even when the VMs are attested using a secure boot process. For instance, as the level of trust of the VMs may be dependent on the security and trustworthiness of the components of the CSPs and the VMMs, fully secure VMs executing on untrusted VMMs may be untrusted, even if they are securely booted and measured, since various components of the CSPs such as the boot firmware, the VMMs, intermediate software, and/or the like, may be untrusted.

By way of particular example and for purposes of illustration, a fully secure VM may execute on an untrusted VMM. Attestation may be performed at boot time, for instance, during a secure boot process. In some instances, the VMM may receive measurements from various components of the platform, and may report those measurements to the VM for attestation. However, the VMM, which is untrusted, may be able to modify the received measurements. As such, the received measurements from the VMM may not be trustworthy, even when they are received through a secure boot process.

Measurements as used herein may be defined as information based on properties, configuration, code, data structures, content, or another type of object, which may correlate to devices or software, which may be loaded into a memory. The measurements may be hash values based on the information correlated to the hardware and/or software, which may be used for attestation of the devices and/or software, for instance, for an identity, a state, a property, a configuration, or the like, of the hardware and/or software. By way of particular example, measurements for a CPU may include a hash of blocks of the CPU μCode, the firmware, and/or the like.

In some instances, components of the CSPs may be updated after attestation, in which case the original attestation of the VMs may no longer be trustworthy. By way of particular example and for purposes of illustration, a VM may execute on a platform for a CSP, which may include a graphics processing unit (GPU) among various components, in which the GPU is to be updated with a new firmware update. In some instances, the firmware update for the GPU may not require a reboot of the VMs and the platform. In other instances, when a reboot may be necessary, it may not be feasible to reboot the platform and/or the VMs each time a component of the platform is updated. As such, the VMs that have access to the updated GPU may no longer be trustworthy.

Disclosed herein are apparatuses, systems, methods, and computer-readable media that enable flexible attestation of VMs and the components on which the VMs execute. Particularly, a processor may send or cause to be sent measurements for attestation to a measurements manager (MM). The processor may send a first measurement for the processor. The processor may cause a hardware and/or a software to send a second measurement to the MM and may cause a virtual machine (VM) to send a third measurement to the MM. The processor may cause the MM to accumulate the first measurement, the second measurement, and the third measurement and may cause the MM to output the accumulated measurements from the MM for attestation of the VM. The MM may be an out-of-band agent, which may be outside of an attestation chain for a secure boot sequence. In some examples, the processor causes the MM to update the accumulated measurements, for instance, via ad-hoc reporting of measurements from devices after a secure boot sequence has completed, which may enable attestation without a need for a reboot of the VM and the components on which the VM executes.

Through implementation of the features of the present disclosure, the processor may cause MMs to accumulate and output accumulated measurements for attestation, which may provide a more secure and trustworthy attestation of VMs and the components on which the VMs execute. In some examples, the MMs may be out-of-band agents, outside of attestation chains for secure boot sequences, and the processor may cause the MMs to output the measurements for attestation without secure reboot sequences. As such, through implementation of the features of the present disclosure, improvements in the flexibility, speed, and trustworthiness in which attestations of VMs may be attained. This may also result in a reduction in energy and resources consumed for the attestations of VMs.

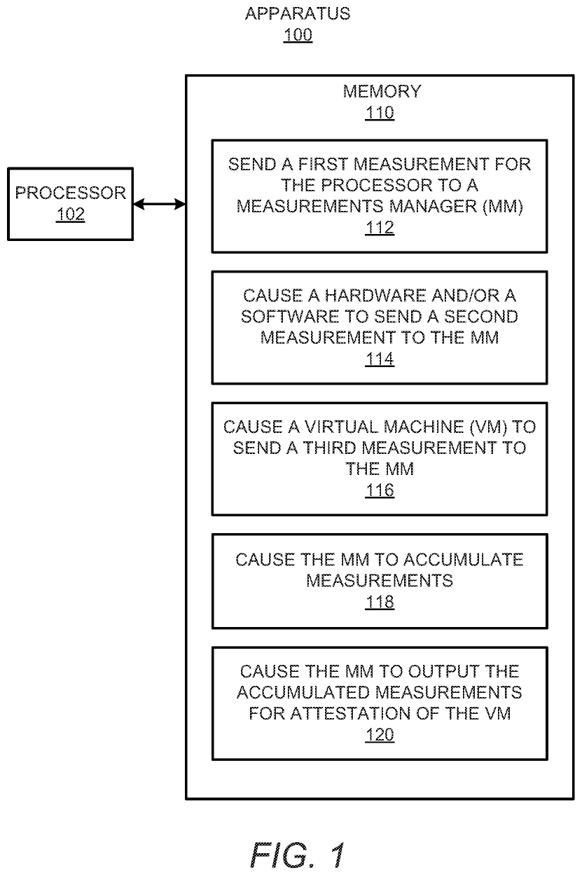

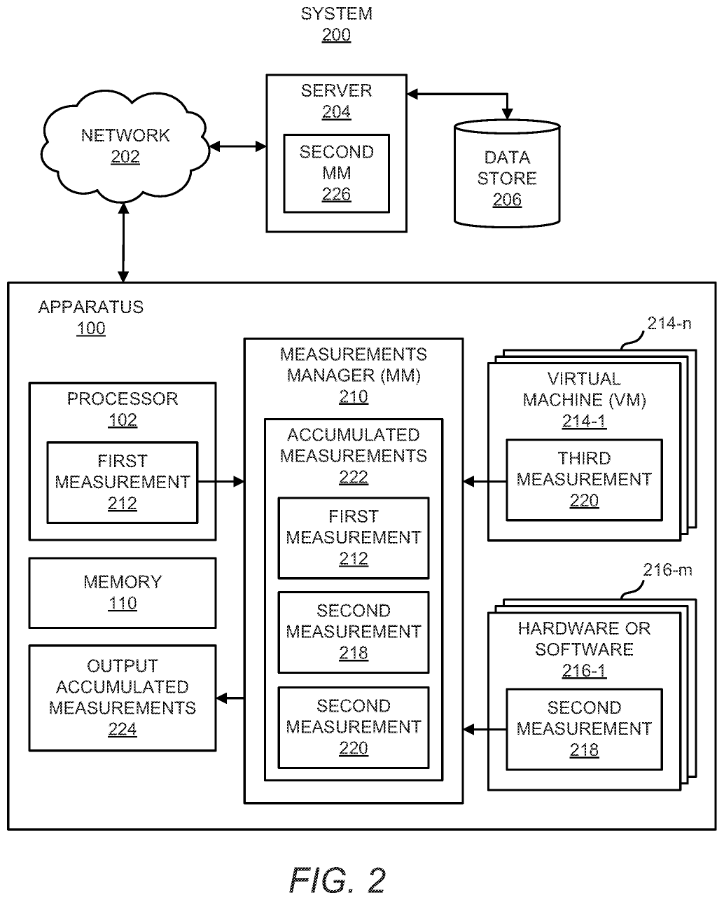

Reference is first made to FIGS. 1-5. FIG. 1 depicts a block diagram of an apparatus 100 that accumulates measurements for attestation and outputs the accumulated measurements 222 for attestation, in accordance with an embodiment of the present disclosure. FIG. 2 depicts a block diagram of a system 200 within which the apparatus depicted in FIG. 1 is implemented, in accordance with an embodiment of the present disclosure.

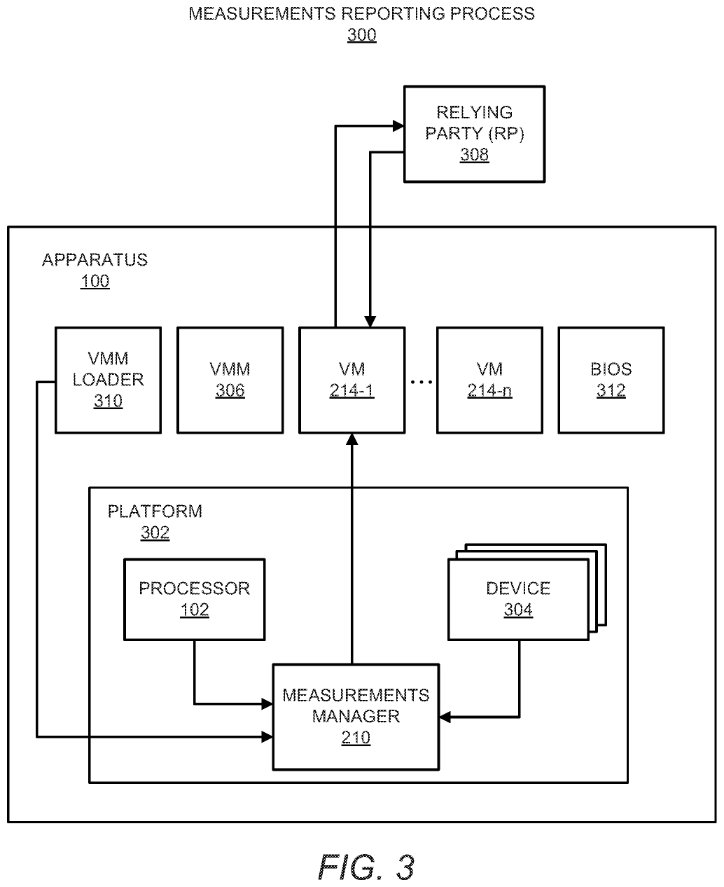

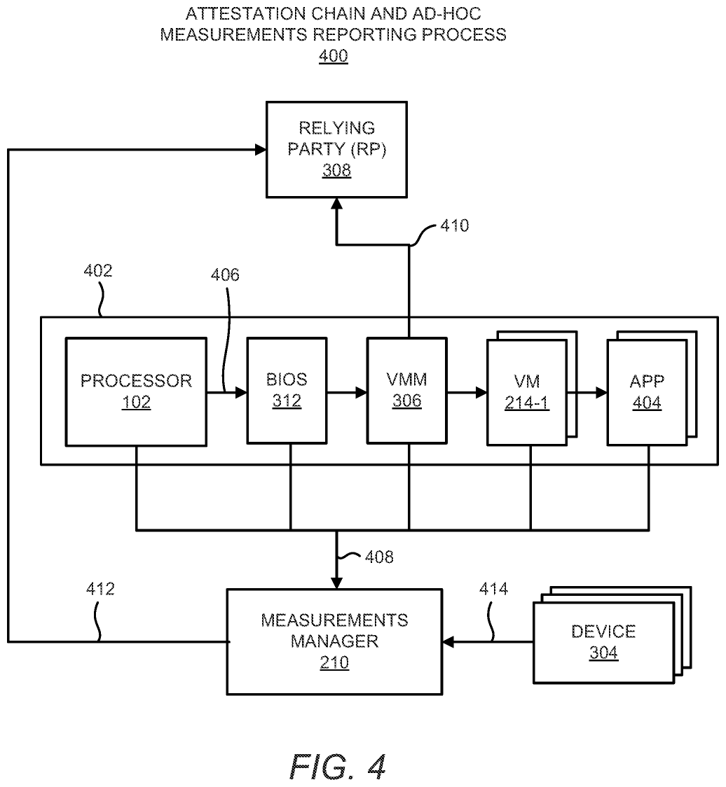

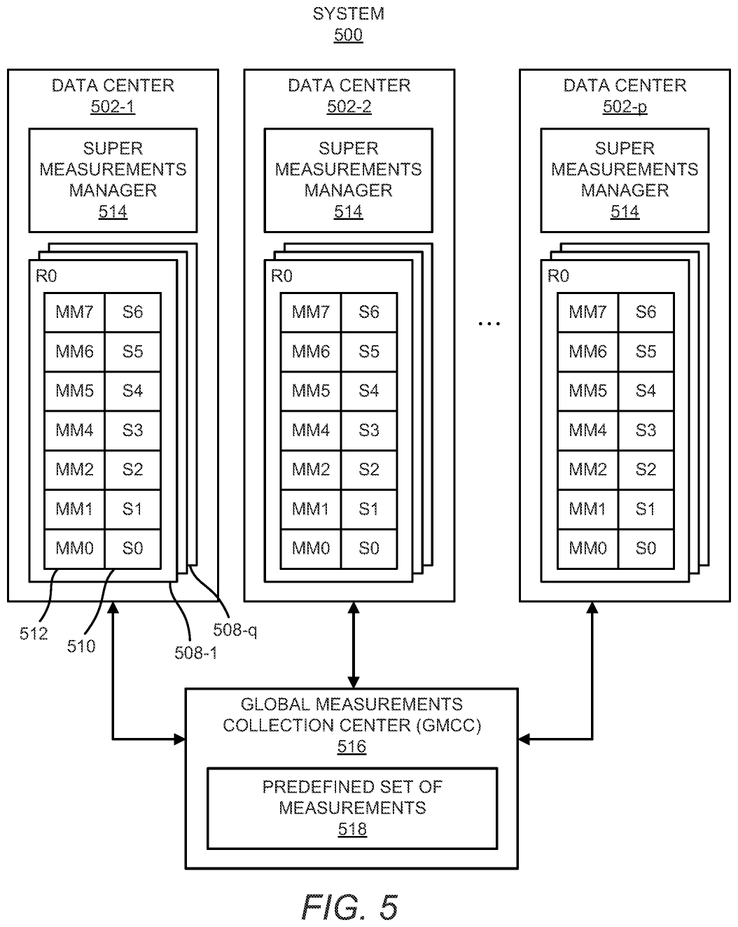

FIG. 3 depicts a flow diagram of a process 300 for measurements reporting, in accordance with an embodiment of the present disclosure. FIG. 4 depicts a flow diagram of a process 400 for measurements reporting including an attestation chain 402 for a secure boot sequence, in which measurements 408 are reported to a measurements manager 210 outside of the attestation chain 402, in accordance with an embodiment of the present disclosure. FIG. 5 depicts a block diagram of a system, including a global measurements collection center 516 and a plurality of data centers 502 including a super measurements manager 514, within which the apparatus depicted in FIG. 1 may be implemented, in accordance with an embodiment of the present disclosure.

It should be understood that the apparatus 100 depicted in FIG. 1, the system 200 depicted in FIG. 2, the process 300 depicted in FIG. 3, the process 400 depicted in FIG. 4, and the system 500 depicted in FIG. 5 may include additional features and that some of the features described herein may be removed and/or modified without departing from the scopes of the apparatus 100, the system 200, the process 300, the process 400, and/or the system 500.

As shown in FIG. 1, the apparatus 100 includes a processor 102 and a memory 110. The apparatus 100 is a computing device, such as a server, a node in a network (such as a data center or a cloud computing resource), a desktop computer, a laptop computer, a tablet computer, a smartphone, an electronic device such as Internet of Things (IoT) device, and/or the like. The processor 102 includes a semiconductor-based microprocessor, a central processing unit (CPU), an application-specific integrated circuit (ASIC), a field-programmable gate array (FPGA), and/or other hardware device. In some examples, the apparatus 100 includes multiple processors and/or cores without departing from a scope of the apparatus 100. In this regard, references to a single processor as well as to a single memory may be understood to additionally or alternatively pertain to multiple processors and multiple memories.

The memory 110 is an electronic, magnetic, optical, or other physical storage device that contains or stores executable instructions. The memory 110 is, for example, Read Only Memory (ROM), flash memory, solid state drive, Random Access memory (RAM), an Electrically Erasable Programmable Read-Only Memory (EEPROM), a storage device, an optical disc, or the like. The memory 110 may be a non-transitory computer-readable medium. The term “non-transitory” does not encompass transitory propagating signals.

As shown in FIG. 1, the processor 102 executes instructions 112-120 to cause accumulation and output of measurements for attestation of a VM 214-1. The instructions 112-120 may be machine-readable instructions, e.g., non-transitory computer-readable instructions. In other examples, the apparatus 100 includes hardware logic blocks or a combination of instructions and hardware logic blocks to implement or execute functions corresponding to the instructions 112-120.

The apparatus 100 may be connected via a network 202, which may be the Internet, a local area network, and/or the like, to a server 204. In addition, a data store 206 may be connected to the server 204. As shown, the apparatus 100 operates in a cloud environment via the network 202, the server, or the like.

The processor 102 may fetch, decode, and execute the instructions 112 to send, to a measurements manager (MM) 210, a first measurement 212 for the processor 102. The first measurement 212 may be for attestation of the processor 102. The first measurement 212 may be a hash based on information correlated to the processor 102, for instance, information correlated to properties, configuration, μCode, firmware, data structures, and/or the like. The first measurement 212 may be used for attestation of the processor 102, for instance, for an identity, a state, a property, a configuration, or the like, of the processor 102. By way of particular example, the first measurement 212 for the processor 102 may include a hash of blocks of the CPU μCode, the firmware, and/or the like.

The processor 102 may be part of a platform 302 on which multiple VMs, such as the VMs 214-1 to 214-n depicted in FIG. 2, may execute. The platform 302 is defined herein as any hardware and/or software, such as the hardware or the software 216-1 to 216-n depicted in FIG. 2, upon which other applications, processes, or services may be executed. The platform 302 is shown as including the processor 102 and one or more than one device 304 including peripheral devices, on which the VMs 214-1 to 214-n may execute. In some examples, the components on the platform 302 communicate through physical channels or buses, such as inter-integrated circuit (I2C), improved inter-integrated circuit (I3C), and/or the like.

In some examples, an RP 308 accesses the VM 214-1 to execute various types of applications or services. The RP 308 may be an entity, such as an application or service of a tenant of the VM 214-1. The VM 214-1 may execute on a virtual machine manager (VMM) 306 on top of the platform 302. The VMM 306 may create, manage, and govern operations of the VMs 214-1 to 214-n.

The RP 308 may determine whether the VM 214-1 is trustworthy based on attestation of the hardware or the software 216-1 to 216-m on which the VM 214-1 may execute. In some examples, the attestation may be performed based on measurements reported during a secure boot sequence, in which predefined entities in an attestation chain 402 may be sequentially attested. In FIG. 4, the attestation chain 402 is shown as including the processor 102, a basic input/output system (BIOS) 312, the VMM 306, the VMs 214-1 to 214-n, applications 404 executing on the platform 302, and/or the like. In some examples, the attestation chain 402 includes one or more than one of the hardware or the software 216-1 to 216-m, such as the BIOS 312 or the applications 404.

The predefined entities of the attestation chain 312 may be ordered in a predefined order. In some examples, during the secure boot sequence, the processor 102 causes each of the predefined entities to sequentially generate measurements 406 and load, verify, then execute a successor in the attestation chain 402. The secure boot sequence may be executed at predefined points in time or at predefined events, for instance, when the platform 302 is booted or rebooted.

According to examples, the MM 210 is outside of the attestation chain 402. In these examples, the MM 210 is referred to herein as an out-of-band agent. The processor 102 may cause the MM 210 to separately receive, outside of the secure boot sequence, respective measurements 408 from the predefined entities of the attestation chain 402. The measurements 408 may be a hash based on the information correlated to the respective predefined entities of the attestation chain 402, for instance, a hash based on properties, configuration, code, data structures, content, and/or the like, correlated to the respective predefined entities in the attestation chain 402. The measurements 408 may be used for attestation of the predefined entities of the attestation chain 402, for instance, for an identity, a state, a property, a configuration, or the like, of the predefined entities of the attestation chain 402. By way of particular example, the measurement 408 for the processor 102 may include a hash of blocks of the CPU μCode, the firmware, and/or the like of the processor 102. In some examples, the measurement 408 for the processor 102 may be the same as the first measurement 212 depicted in FIG. 2.

The predefined entities in the attestation chain 402 may report measurements 408 outside of the attestation chain 402 to the MM 210. In some examples, during the secure boot sequence, each of the predefined entities in the attestation chain 402 reports respective measurements 408 to the MM 210. In some examples, each of the predefined entities in the attestation chain 402 reports respective measurements to the MM 210 outside of the secure boot sequence, for instance, based on a change to the entity, such a firmware update, or the like, or based on a request from the MM 210 for updated measurements. In some examples, the MM 210 receives measurements from devices 304, which may be devices outside the attestation chain 402.

The processor 102 may fetch, decode, and execute the instructions 114 to cause the hardware or the software 216-1 to send a second measurement 218 to the MM 210. The second measurement 218 may be for attestation of the hardware or the software 216-1. In some examples, the hardware or the software 216-1 is a hardware or a software outside of the attestation chain 402, such as the device 304, or inside of the attestation chain 402, such as the processor 102, the VM 214-1, the BIOS 312, and/or the like. In some examples, the second measurement 218 is a hash based on the information correlated to the hardware or the software 216-1, for instance, a hash based on properties, configuration, code, data structures, content, and/or the like, correlated to the hardware or the software 216-1. The second measurement 218 may be used for attestation of the hardware or the software 216-1, for instance, for an identity, a state, a property, a configuration, or the like, of the hardware or the software 216-1. By way of particular example, the hardware or software 216-1 may be a GPU on the platform 302 that may be accessible to the VM 214-1, and the second measurement 218 for the GPU may include a hash of blocks of the firmware of the GPU, or the like.

In some examples, in response to an update to the hardware or the software 216-1, the processor 102 causes the MM 210 to send a request for the second measurement 218 from the hardware or the software 216-1. In this regard, the second measurement 218 may have updated values based on the update to the hardware or the software 216-1. In some examples, the processor 102 causes the hardware or the software 216-1 to send the second measurement 218 based on the update, without a request for the second measurement 218 from the MM 210.

In some examples, the processor 102 causes the hardware or the software 216-1 to send the second measurement 218 to the MM 210 during the secure boot sequence, outside of the attestation chain 402. Alternatively or additionally, the processor 102 causes the hardware or the software 216-1 to send the second measurement 218 to the MM 210 without performing the secure boot sequence, for instance, in response to an update to the hardware or the software 216-1.

The processor 102 may fetch, decode, and execute the instructions 116 to cause the VM 214-1 to send a third measurement 220 to the MM 210. The third measurement may be for attestation of the VM 214-1. In some examples, the third measurement 220 may be a hash based on information correlated to the VM 214-1, for instance, a hash based on properties, configuration, data structures, content, and/or the like, correlated to the VM 214-1. The third measurement 220 may be used for attestation of the VM 214-1, for instance, for an identity, a state, a property, a configuration, or the like, of the VM 214-1.

In some examples, the processor 102 causes the VM 214-1 to send the third measurement 220 to the MM 210 without performing the secure boot sequence, for instance, in response to a request or an update or the VM 214-1 or the components on which the VM 214-1 may execute. In some examples, the processor 102 causes the VM 214-1 to send the third measurement 220 to the MM 210 during the secure boot sequence. In some examples, the processor 102 causes the first measurement 212, the second measurement 218, and/or the third measurement 220 to be sent to the MM 210 through a physical channel or bus, such as I2C, I3C, and/or the like.

The processor 102 may fetch, decode, and execute the instructions 118 to cause the MM 210 to maintain accumulated measurements 222. The processor 102 may cause the MM 210 to accumulate the first measurement 212, the second measurement 218, and the third measurement 220 as the accumulated measurements 222. In some examples, the processor 102 causes the MM 210 to accumulate the first measurement 212, the second measurement 218, and/or the third measurement 220 after the secure boot sequence has completed. In some instances, the processor 102 causes the MM 210 to accumulate measurements on an ad-hoc basis, at different times and/or based on different events, for instance, in response to an update to the VM 214-1 or the hardware or the software 216-1.

The processor 102 may fetch, decode, and execute the instructions 120 to cause the MM 210 to output the accumulated measurements 222 from the MM 210 for attestation of the processor 102, the hardware or the software 216-1, the VM 214-1, or a combination thereof. In some examples, the RP 308 sends a request for attestation at the VM 214-1. In response to receipt of the request for attestation at the VM 214-1 from the RP 308, the processor 102 may cause the MM 210 to output the accumulated measurements 222. The RP 308 may access the outputted accumulated measurements 224 for attestation of the VM 214-1. In some examples, the processor 102 causes the MM 210 to sign the accumulated measurements 222, for instance, using a cryptographic key. In some examples, as the MM 210, the VM 214-1 or the VMM 306 may have signed the accumulated measurements 222, the signed accumulated measurements 222 may not be modified.

In some examples, in response to the request for attestation at the VM 214-1 from the RP 308, the processor 102 causes the MM 210 to output the accumulated measurements 222 to the RP 308 via the VM 214-1 through a connection 410 between the RP 308 and the VM 214-1. In some examples, the processor 102 causes the MM 210 to output the accumulated measurements 222 directly to the RP 308 via a direct connection 412 between the RP 308 and the MM 210.

According to examples, the processor 102 causes the RP 308 to attest the VM 214-1 based on the accumulated measurements 222, for instance, to determine a level of trust that may be correlated to the VM 214-1. In some examples, the processor 102 causes the RP 308 to compare the accumulated measurements 222 against a predefined set of measurements, such as the predefined set of measurements 518 depicted in FIG. 5. The predefined set of measurements 518 may be referred to herein as “golden measurements.” Based on the comparison, the RP 308 may determine the level of trust correlated to the VM 214-1. In some examples, the predefined set of measurements 518 may be values that define a threshold value of the measurements, or values that define ranges of the measurements correlated to different levels of trust. Based on a determination that the accumulated measurements 222 are within the range or threshold of the predefined set of measurements 518, the RP 308 send a workload to execute inside the VM 214-1, or otherwise, the RP 308 may prevent the workflow from executing inside the VM 214-1.

According to examples, the processor 102 causes the MM 210 to send the accumulated measurements 222 to a second MM 226. In some examples, the second MM 226 may be referred to as a super measurements manager, such as the super measurements manager 514 depicted in FIG. 5. The second MM 226 may collect the sent accumulated measurements 222 from the MM 210 along with accumulated measurements from a plurality of other MMs correlated to a plurality of servers in a data center, such as the data center 502 depicted in FIG. 5.

According to examples, the apparatus 100 and the operation of the MM 210 may be scalable. In some examples, the apparatus 100 may be implemented in the system 500, which may include one or more than one data center 502-1 to 502-p. The data centers 502-1 to 502-p may include a plurality of racks 508-1 to 508-q, each of which may include a plurality of servers 510. The plurality of servers 508 may be the same as the apparatus 100, and may respectively include an MM 512, which may be the same as the MM 210 in the apparatus 100.

The data centers 502-1 to 502-p may include a super measurements manager (super MM) 514, which may collect accumulated measurements 222 from the plurality of MMs 512 from respective servers 510. The super MM 514 may be the same as the second MM 226 depicted in FIG. 2. The super MMs 514 may report the collected measurements from the MMs 512 to a global measurements collection center (GMCC) 516. In some examples, the GMCC 516 maintains the predefined set of measurements 518 based on the collected measurements from the super MMs 514. In some examples, the processor 102 generates the predefined set of measurements 518 based on a set of accumulated measurements received from the GMCC 516.

By way of particular example, the apparatus 100 is the server 510 “S0” in the rack R0 508-1 and the MM 210 is the MM 512 “MM0” correlated with the server 510 “S0” in the rack R0 508-1. Based on the collected accumulated measurements at the super MM 514 from the plurality of MMs 512 correlated to the plurality of racks 508-1 to 508-q in the data center 502-1, the processor 102 may determine the golden measurements, such as the predefined set of measurements 518, to be used as a reference for the attestation of the VM 214-1. In some examples, the predefined set of measurements 518 may be identified based on the accumulated measurements 222 from across the system 500, for instance, based on accumulated measurements from the super MMs 514 correlated to one or more than one of the plurality of data centers 502-1 to 502-p.

In some examples, the predefined set of measurements 518 are based on accumulated measurements from a predefined group of servers 510 in the system 500. For instance, the predefined set of measurements 518 may be generated based on a relatively large number of servers 510 across the system 500, for instance, all currently running servers 510, a predefined group of trusted servers that are running a predefined configuration, and/or the like. In some examples, based on a determination that the accumulated measurements 222 from the MM 210 are within a range of the predefined set of measurements 518, the processor 102 causes the VM 214-1 to execute a workload for the RP 308.

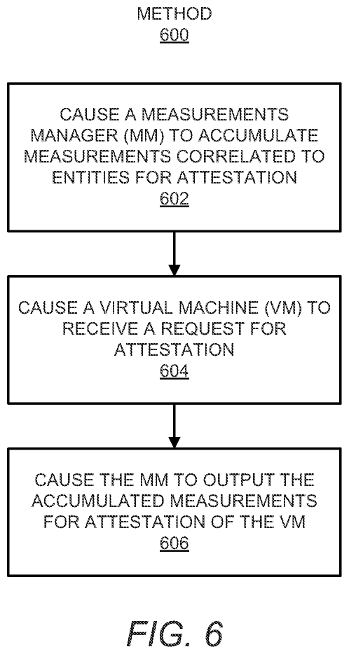

Various manners in which a processor implemented on the apparatus 100 may operate are discussed in greater detail with respect to the method depicted in FIG. 6. FIG. 6 depicts a flow diagram of a method 600 for accumulating measurements for attestation at a measurements manager 210 and outputting the accumulated measurements 222 in response to a request for attestation, in accordance with an embodiment of the present disclosure. It should be understood that the method 600 depicted in FIG. 6 may include additional operations and that some of the operations described therein may be removed and/or modified without departing from the scope of the method 600. The description of the method 600 is made with reference to the features depicted in FIGS. 1 to 5 for purposes of illustration.

At block 602, the processor 102 causes the MM 210 to accumulate measurements correlated to entities for attestation. The entities may include hardware or software in the attestation chain 402 for attestation of the entities during a secure boot sequence. In some examples, the MM 210 may be outside of the attestation chain 402. For instance, the entities in the attestation chain 402 may include the processor 102, the BIOS, the VMM 306, the VMs 214-1 to 214-n, the applications 404, and/or the like.

At block 604, the processor 102 causes the VM 214-1 to receive a request for attestation from the RP 308 accessing the VM 214-1. At block 606, the processor 102, in response to receipt of the request for attestation from the RP 308, causes the MM 210 to output the accumulated measurements 222 for attestation of the VM 214-1. In some examples, the processor 102 causes the MM 210 to output the accumulated measurements 222 to the RP 308 via the VM 214-1 or directly from the MM 210 to the RP 308.

According to examples, the processor 102 determines whether a device upon which the VM 214-1 may execute, such as one of multiple devices 304, is updated. The device 304 may be an entity in the attestation chain 402 or may be outside the attestation chain 402. By way of particular example and for purposes of illustration, the device 304 is a GPU, which may be outside of the attestation chain 402. In some examples, the GPU is updated without requiring a restart of the VM 214-1 or the platform 302. Based on a determination that the device 304 is updated, the processor 102 may cause the MM 210 to request an updated measurement 414 from the updated device 304. In some examples, the device 304 may send the updated measurement to the MM 210 through a physical channel or bus, such as I2C, I3C, and/or the like.

In some examples, the processor 102 causes the MM 210 to update the accumulated measurements 222 based on the updated measurement 414 from the updated device 304. In some examples, the processor 102 causes the MM 210 to update the accumulated measurements 222 based on an update to the device 304 among the entities after the secure boot sequence has completed.

In some examples, the processor 102 causes the MM 210 to send the accumulated measurements 222 to a second MM 226. The second MM 226 may be the same as the super MMs 514 depicted in FIG. 5. The super MM 514 may collect the accumulated measurements 222 from a plurality of MMs 512 correlated to a plurality of servers 510 in a data center, such as the data center 502-1. Based on the collected accumulated measurements 222 at the super MM 514 from the plurality of MMs 512, the processor 102 may determine a predefined set of measurements that may be reference measurements for the attestation, such as the predefined set of measurements 513 maintained in the GMCC 516. Based on a determination that the output accumulated measurements 224 from the MM 210 are within a range of the predefined set of measurements 513, the processor 102 may cause the VM 214-1 to execute a workload for the RP 308.

Some or all of the operations set forth in the method 600 may be included as utilities, programs, or subprograms, in any desired computer accessible medium. In addition, the method 600 may be embodied by computer programs, which may exist in a variety of forms both active and inactive. For example, they may exist as machine-readable instructions, including source code, object code, executable code or other formats. Any of the above may be embodied on a non-transitory computer-readable storage medium.

Examples of non-transitory computer-readable storage media include computer system RAM, ROM, EPROM, EEPROM, and magnetic or optical disks or tapes. It is therefore to be understood that any electronic device capable of executing the above-described functions may perform those functions enumerated above.

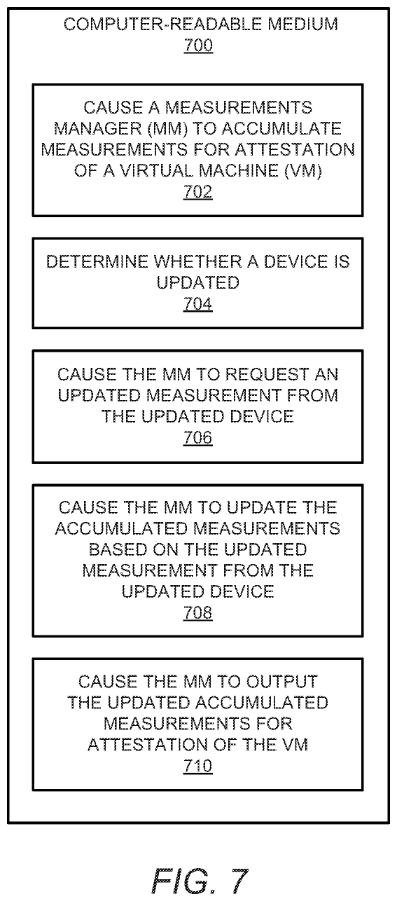

Turning now to FIG. 7, there is shown a block diagram of a computer-readable medium 700 that has stored thereon computer-readable instructions to accumulate measurements for attestation at a measurements manager, such as the MM 210, and to update the accumulated measurements 222 based on updated measurements from an updated device 304, in accordance with an embodiment of the present disclosure. It should be understood that the computer-readable medium 700 depicted in FIG. 7 may include additional instructions and that some of the instructions described herein may be removed and/or modified without departing from the scope of the computer-readable medium 700 disclosed herein. The description of the computer-readable medium 700 is made with reference to the features depicted in FIGS. 1 to 5 for purposes of illustration. The computer-readable medium 700 may be a non-transitory computer-readable medium. The term “non-transitory” does not encompass transitory propagating signals.

As shown, the computer-readable medium 700 has stored thereon machine-readable instructions 702-710 that a processor disposed in an apparatus 100 may execute. The computer-readable medium 700 is an electronic, magnetic, optical, or other physical storage device that contains or stores executable instructions. The computer-readable medium 700 is, for example, Random Access memory (RAM), an Electrically Erasable Programmable Read-Only Memory (EEPROM), a storage device, an optical disc, and the like.

The processor may fetch, decode, and execute the instructions 702 to cause the MM 210 to accumulate measurements, such as the first measurement 212, the second measurement 218, and the third measurement 220 depicted in FIG. 2, for attestation of a VM, such as the VM 214-1.

The processor may fetch, decode, and execute the instructions 704 to determine whether a device, such as the device 304, is updated. The VM 214-1 may access the device 304 and the device 304 may be a component of the platform 302 upon which the VM 214-1 may execute.

The processor may fetch, decode, and execute the instructions 706 to, based on a determination that the device 304 is updated, cause the MM 210 to request an updated measurement 414 from the updated device 304.

The processor may fetch, decode, and execute the instructions 708 to cause the MM 210 to update the accumulated measurements 222 based on the updated measurement 414 from the updated device 304.

The processor may fetch, decode, and execute the instructions 710 to, in response to a request for attestation of the VM 214-1 from the RP 308 accessing the VM 214-1, cause the MM 210 to output the updated accumulated measurements 222 for attestation of the VM 214-1.

In some examples, the VM 214-1 and the device 304 are components within the attestation chain 402 for generating measurements for attestation during a secure boot sequence, and the MM 210 may be outside of the attestation chain 402. The processor may cause the MM 210 to update the accumulated measurements 222 based on the updated measurement 414 from the updated device 304 after a secure boot sequence has completed. In some examples, based on a determination that the updated accumulated measurements 222 from the MM 210 are within a range of the predefined set of measurements 518, the processor causes the VM 214-1 to execute a workload for the RP 308.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor; and
a memory on which is stored machine-readable instructions that when executed by the processor, cause the processor to:
send, to a measurements manager (MM), a first measurement for the processor, the first measurement being for attestation of the processor;
cause a hardware and/or a software to send a second measurement to the MM, the second measurement being for attestation of the hardware and/or the software;
cause a virtual machine (VM) to send a third measurement to the MM, the third measurement being for attestation of the VM;
cause the MM to accumulate the first measurement, the second measurement, and the third measurement; and
cause the MM to output the accumulated measurements from the MM for attestation of the processor, the hardware and/or the software, the VM, or a combination thereof.

2. The apparatus of claim 1, wherein the processor, the hardware and/or the software, and the VM are in an attestation chain for sequentially generating measurements for attestation during a secure boot sequence, and wherein the MM is outside of the attestation chain.

3. The apparatus of claim 2, wherein the attestation chain includes a plurality of entities including the processor, a basic input/output system (BIOS), a virtual machine manager (VMM) loader, a VMM, a plurality of VMs executing in the VMM including the VM, the hardware and/or the software, or a combination thereof,
wherein the instructions cause the processor to cause the MM to separately receive, outside of the secure boot sequence, respective measurements from the plurality of entities.

4. The apparatus of claim 1, wherein the instructions cause the processor to:
cause the MM to accumulate the first measurement, the second measurement, and/or the third measurement after a secure boot sequence has completed.

5. The apparatus of claim 1, wherein the instructions cause the processor to:
in response to an update to the hardware and/or the software, cause the MM to send a request for the second measurement from the hardware and/or the software, the second measurement being based on the update to the hardware and/or the software.

6. The apparatus of claim 1, wherein the instructions cause the processor to:
in response to receipt of a request for attestation at the VM from a relying party (RP), cause the MM to output the accumulated measurements, the RP to access the outputted accumulated measurements for attestation of the VM, wherein the MM signed the accumulated measurements, wherein the VM or a virtual machine manager (VMM) for the VM is not able to modify the signed accumulated measurements.

7. The apparatus of claim 1, wherein the instructions cause the processor to:
in response to receipt of a request for attestation at the VM from a relying party (RP), cause the MM to output the accumulated measurements to the RP via the VM or cause the MM to output accumulated measurements directly to the RP.

8. The apparatus of claim 1, wherein the instructions cause the processor to:
cause the MM to send the accumulated measurements to a second MM in a data center, the second MM to collect the sent accumulated measurements from the MM along with accumulated measurements from a plurality of other MMs correlated to a plurality of servers in racks of servers in the data center.

9. The apparatus of claim 8, wherein the instructions cause the processor to:
based on the collected accumulated measurements at the second MM from the plurality of other MMs, determine a predefined set of measurements to be used as a reference for the attestation of the VM; and
based on a determination that the accumulated measurements from the MM are within a range of the predefined set of measurements, cause the VM to execute a workload for a relying party (RP).

10. The apparatus of claim 9, wherein the instructions cause the processor to:
cause the MM to send the accumulated measurements to a global measurements collection center (GMCC), wherein the GMCC is to collect accumulated measurements from a plurality of data centers, the plurality of data centers including the data center; and
based on the collected accumulated measurements from the GMCC, determine a predefined set of measurements to be used as a reference for the attestation of the VM, the predefined set of measurements to be generated based on a predefined group of servers having a predefined configuration among the plurality of data centers.

11. A method comprising:
causing, by a processor, a measurements manager (MM) to accumulate measurements correlated to entities for attestation, wherein the entities are hardware and/or software and are in an attestation chain for attestation of the entities during a secure boot sequence, and the MM is outside of the attestation chain;
causing, by the processor, a virtual machine (VM) to receive a request for attestation from a relying party (RP) accessing the virtual machine (VM); and
in response to the request for attestation from the RP, causing, by the processor, the MM to output the accumulated measurements for attestation of the VM.

12. The method of claim 11, further comprising:
determining whether a device upon which the VM executes is updated;
based on a determination that the device is updated, causing the MM to request an updated measurement from the updated device; and
causing the MM to update the accumulated measurements based on the updated measurement from the updated device.

13. The method of claim 11, further comprising:
causing the MM to update the accumulated measurements based on an update to a device among the entities after the secure boot sequence has completed.

14. The method of claim 11, further comprising:
causing the MM to send the accumulated measurements to a second MM, the second MM to collect accumulated measurements from a plurality of MMs correlated to a plurality of servers in a data center.

15. The method of claim 14, further comprising:
based on the collected accumulated measurements at the second MM from the plurality of MMs, determining a predefined set of measurements that are reference measurements for the attestation.

16. The method of claim 15, further comprising:
based on a determination that the accumulated measurements from the MM are within a range of the predefined set of measurements, causing the VM to execute a workload for the RP.

17. A computer-readable medium on which is stored machine-readable instructions that when executed by a processor, cause the processor to:
cause a measurements manager (MM) to accumulate measurements for attestation of a virtual machine (VM);
determine whether a device is updated, the device being accessible to the VM;
based on a determination that the device is updated, cause the MM to request an updated measurement from the updated device;
cause the MM to update the accumulated measurements based on the updated measurement from the updated device; and
in response to a request for attestation of the VM from a relying party (RP) accessing the VM, cause the MM to output the updated accumulated measurements for attestation of the VM.

18. The computer-readable medium of claim 17, wherein the VM and the device are in an attestation chain for generating measurements for attestation during a secure boot sequence, and wherein the MM is outside of the attestation chain.

19. The computer-readable medium of claim 17, wherein the instructions cause the processor to:
cause the MM to update the accumulated measurements based on the updated measurement from the updated device after a secure boot sequence has completed.

20. The computer-readable medium of claim 17, wherein the instructions cause the processor to:
based on a determination that the updated accumulated measurements from the MM are within a range of a predefined set of measurements, cause the VM to execute a workload for the RP.
